(19) United States
(12) Patent Application Publication
(10) Pub. No.: US 2018/0027595 A1
(43) Pub. Date: Jan. 25, 2018

(54) METHODS AND DEVICES FOR RANDOM ACCESS

(71) Applicant: Telefonaktiebolaget LM Ericsson (publ), Stockholm (SE)

(72) Inventors: Jianfeng WANG, Beijing (CN); Zhiheng GUO, Beijing (CN); Huaisong ZHU, Beijing (CN)

(73) Assignee: Telefonaktiebolaget LM Ericsson (publ), Stockholm (SE)

(21) Appl. No.: 15/549,590

(22) PCT Filed: Feb. 13, 2015
(86) PCT No.: PCT/CN2015/073003

§ 371 Date: Aug. 8, 2017

(51) Int. Cl. H04W 74/08; H04W 72/04

(52) U.S. Cl. CPC H04W 74/0841; H04W 72/042; H04W 88/02

(57) ABSTRACT

The present disclosure relates to a method used in a user terminal for performing random access to a network, and to the associated user terminal. The method includes: transmitting a random access request to the network, the random access request containing a preamble; receiving two or more random access responses from the network, the two or more random access responses corresponding to the preamble; selecting one random access response from the received two or more random access responses; and using resource indicated by the selected random access response for accessing to the network. The present disclosure also relates to a method used in a network node for controlling random access of one or more user terminals to the network node, and to the associated network node.

### TECHNICAL FIELD

The present disclosure generally relates to the technical field of wireless communications, and particularly, to a method implemented in a user terminal for performing random access to a network node as well as to the associated user terminal, and to a method used in a network node for controlling random access of one or more user terminals to the network node as well as to the associated network node.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

One of the most basic requirements for any cellular system is the possibility for a user terminal (also called as User Equipment (UE)) to initially request a connection setup to a network side (e.g., a base station or an eNodeB (eNB) in Long-Term Evolution (LTE) or any other appropriate network node that can guide the UE to establish a connection to the network), commonly referred to as random access. In LTE, the random access procedure comes in two forms, allowing access to be either contention-based or contention-free.

In a contention-based random access procedure, a random access preamble is randomly chosen by the UE, with the result that it is possible for more than one UE to simultaneously transmit the same preamble (i.e., a contention occurs), leading to a need for a subsequent contention resolution process. The smaller the total number of preambles available in the contention-based random access procedure is, the higher the contention possibility becomes.

For a content-free random access procedure, the network side has the option of preventing contention occurring by allocating a dedicated preamble to a UE, resulting in contention-free access. This procedure is constrained to a limited amount of available preambles. That is, the smaller the total number of preambles available in the contention-free random access procedure is, the smaller the number of UEs simultaneously accessing to the network becomes.

With the emerging 5^{th} Generation (5G) technologies such as Millimeter-Wave (MMW) technology, where the use of a large number of antenna elements is of great interest, especially in conjunction with higher carrier frequencies, constraints caused by the limited amount of available preambles are increasingly apparent.

For example, to act against with phase noise and frequency error for the higher carrier frequency and reduce the hardware complexity with multiple antenna elements, a new random-access preamble format has been proposed. Such a preamble is constructed by repeating a short sequence multiple times. This would increase the access collision probability, thereby confining the random access capacity.

There is a need for a solution to reduce the random access collision possibility while improving the random access capacity.

### SUMMARY

It is in view of the above considerations and others that the various embodiments of the present technology have been made. To be specific, the present disclosure proposes to increase the number of random access responses against each preamble available in either the contention-based random access or the contention-free random access.

According to a first aspect of the present disclosure, there is provided a method used in a user terminal for performing random access to a network. The method includes: transmitting a random access request to the network, the random access request containing a preamble; receiving two or more random access responses from the network, the two or more random access responses corresponding to the preamble; selecting one random access response from the received two or more random access responses; and using resource indicated by the selected random access response for accessing to the network.

In an embodiment, the preamble corresponds to one or more Identities (IDs), each of which identifies a time-frequency slot in which the preamble is detected. Each of the one or more IDs indicates one or more Physical Downlink Control CHannel (PDCCH) or enhanced PDCCH (ePDCCH). Each of the one or more PDCCH or ePDCCH indicates a PDSCH payload, in which one or more of the received random access responses are carried.

In an embodiment, selecting one random access response from the received two or more random access responses comprises: randomly selecting one random access response from the received two or more random access responses.

In an embodiment, selecting one random access response from the received two or more random access responses includes: selecting one random access response having the strongest receiving strength among the received two or more random access responses.

According to a second aspect of the present disclosure, there is provided a method used in a network node for controlling random access of one or more user terminals to the network node. The method includes: for each of the one or more user terminals, receiving one or more random access requests from the user terminal, the one or more random access requests containing a preamble; and transmitting two or more random access responses to the user terminal, the two or more random access responses corresponding to the preamble.

In an embodiment, the method further includes: determining one or more IDs, each of which identifies a time-frequency slot in which the preamble is detected; and establishing one or more PDCCH or ePDCCH based on the determined one or more IDs, each of the one or more IDs indicating one or more PDCCH or ePDCCH, and each of the one or more PDCCH or ePDCCH indicating a PDSCH payload. Transmitting two or more random access responses to the user terminal includes transmitting one or more of the random access responses to the user terminal via the PDSCH payload.

In an embodiment, the method further includes: determining a total number of one or more random access requests received from the one or more user terminals and containing a same preamble; and determining a total number of random access responses for the one or more random access requests, based on the total number of the one or more random access requests.

In an embodiment, determining a total number of one or more random access requests includes: determining the total number of the one or more random access requests, based on Angles of Arrivals (AoAs) of signals carrying the one or more random access requests.

In an embodiment, determining a total number of one or more random access requests includes: determining the total number of the one or more random access requests, based on time difference between preamble detection peaks.

According to a third aspect of the present disclosure, there is provided a user terminal performing random access to a network. The user terminal includes: a transmitting unit configured to transmit a random access request to the network, the random access request containing a preamble; a receiving unit configured to receive two or more random access responses from the network, the two or more random access responses corresponding to the preamble; a selecting unit configured to select one random access response from the received two or more random access responses; and a random access unit configured to use resource indicated by the selected random access response for accessing to the network.

According to a fourth aspect of the present disclosure, there is provided a network node for controlling random access of one or more user terminals to the network node. The network node includes: a receiving unit configured to receive, for each of the one or more user terminals, one or more random access requests from the user terminal, the one or more random access requests containing a preamble; and a transmitting unit configured to transmit, for each of the one or more user terminals, two or more random access responses to the user terminal, the two or more random access responses corresponding to the preamble.

According to a fifth aspect of the present disclosure, there is provided a computer-readable storage medium storing instructions that when executed, causing one or more computing devices to perform the method according to any one of the first and second aspects

The above embodiments of the first and second aspects are also applicable for the third and fourth aspects, respectively.

With the embodiments of the present disclosure, two or more random access responses are used for responding to a same preamble used by one or more user terminals. This can increase possibility of distinguishing more than one user terminals that use the same preamble for accessing to the network, thereby reducing the random access collision possibility while improving the random access capacity.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates the traditional random access procedure in LTE.

FIG. 2 illustrates a sequence diagram of a method 200 in a wireless communication system.

FIG. 3 illustrates three examples showing how to implement transmission of two or more RARs according to embodiments of the present disclosure.

FIG. 4 shows a flowchart of a method 400 used in a UE for performing random access to a network according to embodiments of the present disclosure.

FIG. 5 shows a flowchart of a method 500 used in a network node for controlling random access of one or more user terminals to the network node according to embodiments of the present disclosure.

FIG. 6 illustrates an exemplary scenario where more than one UEs transmit more than one random access requests to the eNB by using the same preamble.

FIG. 7 illustrates another exemplary scenario where more than one UEs transmit more than one random access requests to the eNB by using the same preamble.

FIG. 8 is a schematic block diagram of a UE 800 according to embodiments of the present disclosure.

FIG. 9 is a schematic block diagram of a network node 900 according to embodiments of the present disclosure.

FIG. 10 schematically shows an embodiment of an arrangement 1000 which may be used in the UE 800 or the network node 900.

### DETAILED DESCRIPTION OF EMBODIMENTS

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

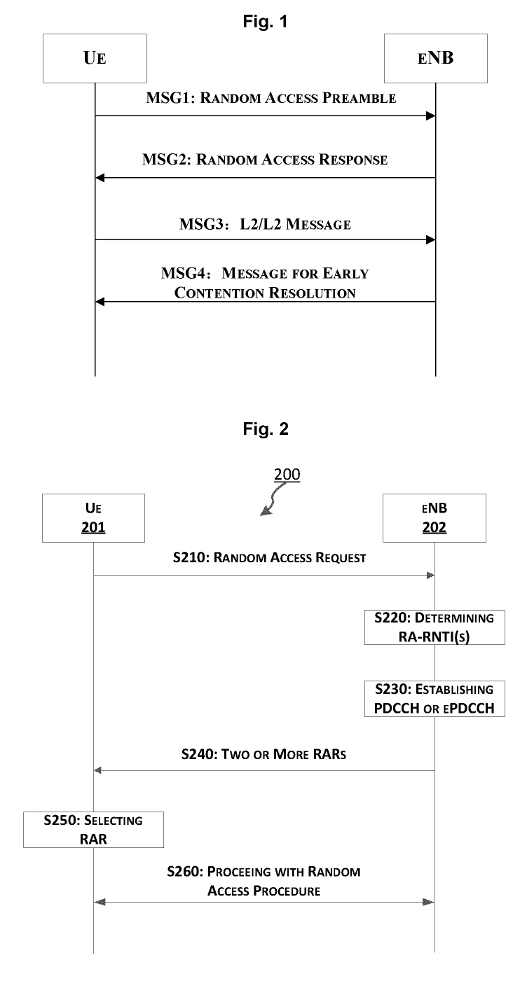

FIG. 1 illustrates the traditional random access procedure in LTE, which consists of the following four steps:
Step 1: Random access preamble transmission (MSG1);
Step 2: Random access response (MSG2);
Step 3: Layer 2/Layer 3 (L2/L3) message (MSG3);
Step 4: Contention resolution message (MSG4).

As shown in FIG. 1, this is a contention-based random access procedure. The conventional contention-free random access procedure is similar except for Step 4.

At Step 1, the UE selects one of preambles available in the contention-based random access procedure, e.g., 64−N_{cf} as specified in LTE, where N_{cf} is the number of preambles reserved by the eNB for contention-free random access.

Once detecting the preamble in a time-frequency slot, the eNB determines an ID, called as the Random Access Radio Network Temporary Identifier (RA-RNTI) in LTE, identifying the time-frequency slot in which the preamble was detected. Then, at Step 2, the eNB sends a Random Access Response (RAR) addressed with the ID on the Physical Downlink Shared CHannel (PDSCH). If multiple UEs had collided by selecting the same preamble in the same preamble time-frequency resource, they would each receive the RAR.

At Step 3, the UE transmits Layer 2/Layer 3 (L2/L3) Message to the eNB by using resource indicated by the RAR. This message is the first scheduled uplink transmission on the PUSCH and makes use of Hybrid Automatic Repeat reQuest (HARQ). It conveys the actual random access procedure message, such as an RRC connection request, tracking area update, or scheduling request. It includes a temporary Cell Radio Network Temporary Identifier (C-RNTI) allocated in the RAR at Step 2 and either the C-RNTI if the UE already has one (RRC_CONNECTED UEs) or the (unique) 48-bit UE identity. In case of a preamble collision having occurred at Step 1, the colliding UEs will receive the same Temporary C-RNTI through the RAR and will also collide in the same uplink time-frequency resources when transmitting their L2/L3 message.

At step 4, the eNB transmits a contention resolution message to the UE.

The present disclosure proposes to improve random access capacity by introducing two or more RARs. To be specific, the present disclosure configures two or more RARs, instead of a single RAR, for responding to a same preamble used by one or more UEs. Although some descriptions are made by taking LTE as an example, it would be appreciated by those skilled in the art that the present disclosure is also applicable in the 5G technologies or any other wireless communication systems.

FIG. 2 illustrates a sequence diagram of a method 200 in a wireless communication system, which includes a UE 201 and a network node 202, such as eNB or any other network node responsible for controlling the UE 201's accessing to the corresponding network. The network here may be a LTE network, a 5G network, or the other appropriate wireless network.

As shown in FIG. 2, the method 200 begins with step S210, in which the UE 201 transmits a random access request (e.g., MSG1 as shown in FIG. 1) to the network node 202. The random access request contains a preamble, which is, e.g., selected by the UE 201 from available predefined preambles, or assigned by the network node 202.

Once detecting the preamble in a time-frequency slot, the network node 202 determines one or more IDs identifying the time-frequency slot, e.g., one or more RA-RNTIs, at step S220. Each of the one or more IDs indicates one or more PDCCH or ePDCCH. This step differs from the legacy technology such as LTE in configuring one or more IDs, instead of a single one, corresponding to one preamble. As done in LTE, correspondence between one or more IDs and one preamble may be preconfigured at the network side and the UE side. Then, the network node may determine one or more IDs following such correspondence. Also, the total number of the one or more IDs corresponding to the preamble may be determined in this way.

At step S230, the network node 202 establishes one or more PDCCH or ePDCCH based on the determined one or more IDs. Each of the one or more PDCCH or ePDCCH indicates a PDSCH payload.

At step S240, the network node 202 transmits to the UE 201 two or more RARs corresponding to the preamble via the PDSCH payload. This step differs from MSG2 as shown in FIG. 1 mainly in using two or more RARs instead of a single RAR.

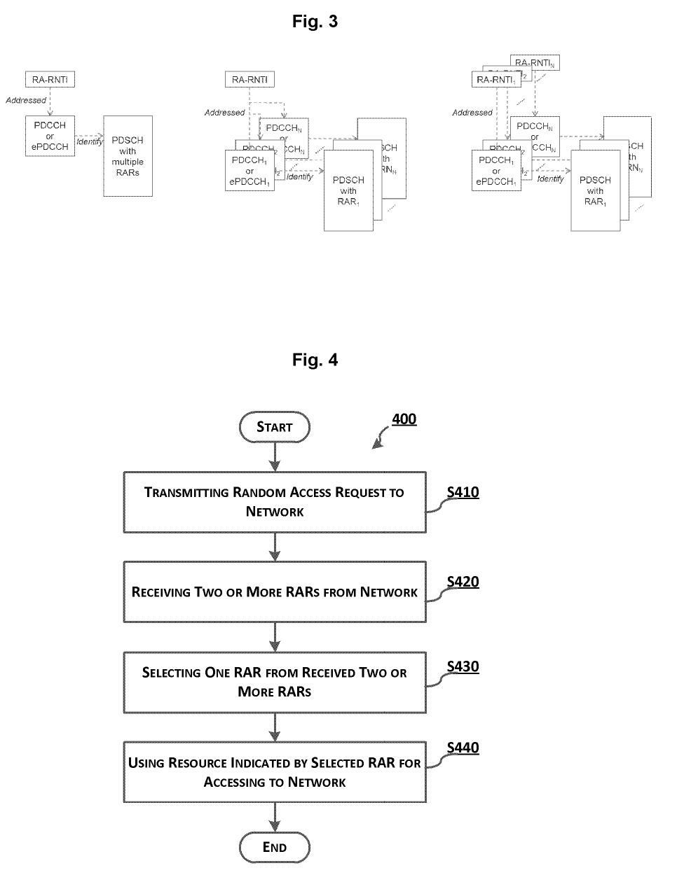

FIG. 3 illustrates three examples showing how to implement transmission of two or more RARs according to embodiments of the present disclosure.

In a first example as shown in the left-most part of FIG. 3, the network node 202 determines one RA-RNTI, which indicates one PDCCH or ePDCCH indicating a PDSCH payload, and then the network node 202 transmits the two or more RARs in the PDSCH payload. For example, the network node 202 may transmit N RARs in the PDSCH payload, wherein N is an integer larger than or equal to 2.

In a second example as shown in the middle part of FIG. 3, the network node 202 determines one RA-RNTI, which indicates more than one PDCCH or ePDCCH (e.g., N PDCCH or ePDCCH). Each PDCCH or ePDCCH indicates a PDSCH payload, thereby there are N PDSCH payloads in total for carrying RAR(s). In this way, the network node 202 can transmit the two or more RARs (e.g., N RARs in this example) by transmitting one RAR in one PDSCH payload.

In a third example as shown in the right-most part of FIG. 3, the network node 202 determines more than one RA-RNTIs, e.g., N RA-RNTIs, corresponding to the preamble received via the random access request. Each RA-RNTI indicates one PDCCH or ePDCCH. Each PDCCH or ePDCCH indicates one PDSCH payload. Thus, there are also N PDSCH payloads in total for carrying RAR(s). In this way, the network node 202 can transmit the two or more RARs (e.g., N RARs in this example) by transmitting one RAR in one PDSCH payload.

In addition to these three examples, the present disclosure may also be embodied as a combination of the three examples. For example, the network node 202 determines N RA-RNTIs, each of which indicates N PDCCH or ePDCCH. Each PDCCH or ePDCCH indicates one PDSCH payload, which carries N RARs. In this view, the network node 202 can transmit N³ RARs in total to the UE 201.

Return to FIG. 2. At step S240, the UE 201 correspondingly receives the two or more RARs from the network node 202. For example, the UE 201 may use one or more IDs corresponding to the preamble for detecting the one or more PDCCH or ePDCCH, and then obtain the two or more RARs carried in PDSCH payload(s) indicated by the one or more PDCCH or ePDCCH.

At step S250, the UE 201 selects one RAR from the two or more RARs received from the network node 202. The UE may randomly select one random access response from the received two or more random access responses. Alternatively, the UE may perform the selection following a certain criteria. For example, when each ID indicates two or more PDCCH or ePDCCH, the UE may select one RAR having the strongest receiving strength/quality among the received two or more RARs.

At step S260, the UE 201 proceeds with the random access procedure by using resource indicated by the selected RAR. For example, the UE 201 may transmit MSG3 as show in FIG. 1 as well as other appropriate operations for random access.

One major advantage with the method 200 is that two or more RARs are used for responding to a same preamble used by one or more user terminals, especially by more than one user terminals. This can increase possibility of distinguishing more than one user terminals that use the same preamble for accessing to the network, thereby reducing the random access collision possibility while improving the random access capacity.

In the following, the method 200 will be described in detail from two sides, i.e., the UE side and the network side, respectively.

FIG. 4 shows a flowchart of a method 400 used in a UE for performing random access to a network, e.g., a LTE network, a 5G network, or the other appropriate wireless network, according to embodiments of the present disclosure.

At step S410, the UE transmits a random access request to the network. As mentioned previously, the random access request contains a preamble, which may be, e.g., selected by the UE from available predefined preambles or assigned by the network, e.g., by eNB in LTE.

At step S420, the UE receives two or more random access responses from the network. The two or more random access responses correspond to the preamble.

According to some embodiments of the present disclosure, the preamble corresponds to one or more IDs (e.g., RA-RNTI in LTE), each of which identifies a time-frequency slot in which the preamble is detected. In this example, each of the one or more IDs indicates one or more PDCCH or ePDCCH, and each of the one or more PDCCH or ePDCCH indicates a PDSCH payload, in which one or more of the received random access responses are carried.

At step S430, the UE selects one random access response from the received two or more random access responses.

As an implementation, the UE randomly selects one random access response from the received two or more random access responses.

As another implementation, the UE selects one random access response based on a certain criteria. For example, when each ID indicates two or more PDCCH or ePDCCH, the UE may select one random access response having the strongest receiving strength/quality among the received two or more random access responses. In scenarios that the received multiple random access responses are from multiple network nodes, when each of the multiple network nodes sends one ID indicates one PDCCH including multiple RARs, the UE may randomly select one random access response from the multiple random access responses corresponding to the PDCCH having the strongest receiving strength/quality.

At step S440, the UE uses resource indicated by the selected random access response for accessing to the network. For example, the UE may proceed with transmitting MSG3 to eNB as shown in FIG. 1, as well as subsequent random access related processing, which will be apparent to those skilled in the art and thus will not be described in detail here.

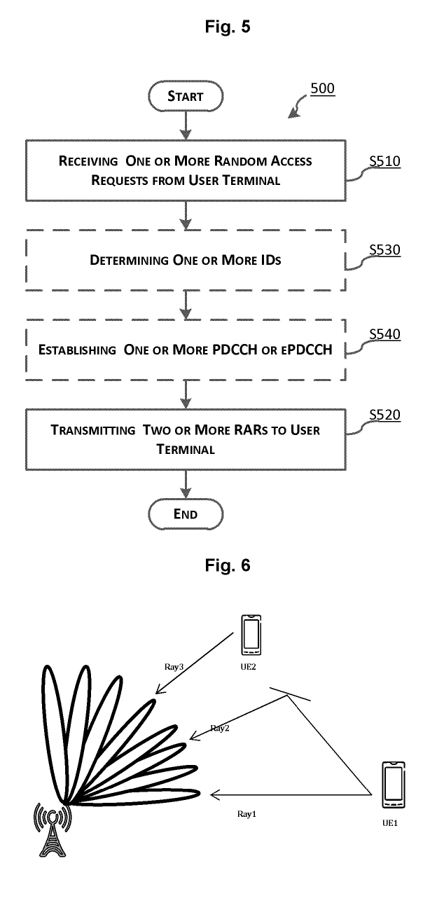

FIG. 5 shows a flowchart of a method 500 used in a network node for controlling random access of one or more user terminals to the network node according to embodiments of the present disclosure. The network node here may be a base station, an eNB, an Access Point or any other network node responsible for random access in a certain coverage in the corresponding network. The network here may be a LTE network, a 5G network, or the other appropriate wireless network.

At step S510, the network node, receives, for each of the one or more user terminals, one or more random access requests from the user terminal. As mentioned previously, the random access request contains a preamble, which may be, e.g., selected by the UE from available predefined preambles or assigned by the network node.

At step S520, the network node transmits, for each of the one or more user terminals, two or more random access responses to the user terminal. The two or more random access responses correspond to the preamble.

In an implementation, the method 500 further includes steps S530 and S540.

At step S530, the network node determines one or more IDs, each of which identifies a time-frequency slot in which the preamble is detected. As mentioned previously, correspondence between IDs and preambles may be preconfigured at the network side and the UE side.

At step S540, the network node establishes one or more PDCCH or ePDCCH based on the determined one or more IDs. Each of the one or more IDs indicates one or more PDCCH or ePDCCH, and each of the one or more PDCCH or ePDCCH indicates a PDSCH payload.

In this implementation, step S520 may be done by transmitting one or more of the random access responses to the user terminal via the PDSCH payload.

According to this implementation, the network node transmits two or more RARs to multiple user terminals using a single preamble. In this way, each of the multiple user terminals using the same preamble can select one RAR from the multiple RARs. Thereby, this can reduce random access collision possibility while improving the random access capacity.

In another implementation, the method 500 further includes: determining a total number of one or more random access requests received from the one or more user terminals and containing a same preamble; and determining a total number of random access responses for the one or more random access requests, based on the total number of the one or more random access requests (not shown).

In some scenarios, the eNB cannot distinguish different random access requests without preambles. That is, it is possible that the eNB cannot distinguish several random access requests containing the same preamble.

There are various manners applicable in determining the total number of one or more random access requests. To be specific, the network node may use physical layer measurement results, including, e.g., spatial information, time difference, frequency offset and power difference, to distinguish multiple random access requests and thereby determine the total number of the random access requests.

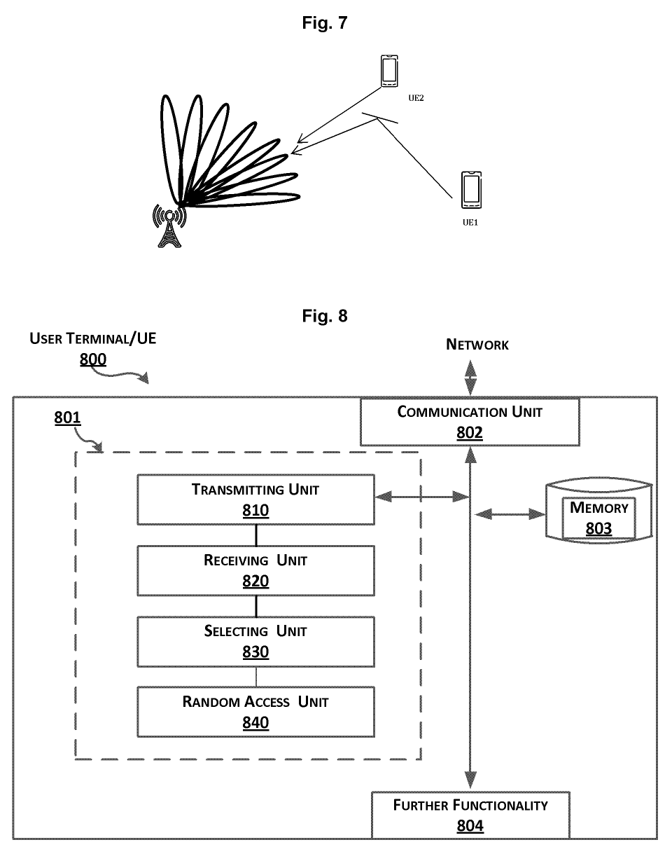

FIG. 6 and FIG. 7 illustrate two exemplary scenarios where more than one UEs transmit more than one random access requests to the eNB by using the same preamble.

As shown in FIG. 6, two access random requests, denoted by Ray 1 and Ray 2, respectively, both come from UE1, and evidently contain the same preamble. Another access random request, denoted by Ray 3 comes from UE2 and is assumed to employ the same preamble as UE1. In this case, these three requests are received in different beams. Then, the network node may determine the total number of the one or more random access requests, based on AoAs of signals carrying the one or more random access requests.

In the scenario as illustrated in FIG. 7, two access random requests come from UE1 and UE2, respectively, and are assumed to employ the same preamble. As shown in FIG. 7, the two access random requests are received in almost one beam. In this case, the network node may determine the total number of the one or more random access requests, based on time difference between preamble detection peaks.

Alternatively, these two manners could be combined for determining the total number of the random access requests, so as to improve accuracy. It would be appreciated that any other appropriate manners are applicable in the present disclosure.

With the total number of the random access requests, the network node may adjust the total number of RARs depending on the total number of random access request(s). For example, if the network node determines that there are three random access requests as shown in FIG. 6, then the network node may determine and transmit at least more than 3 RARs, e.g., 8 RARs, so as to reduce the random access collision as much as possible.

FIG. 8 is a schematic block diagram of a user terminal/UE 800 according to embodiments of the present disclosure. UE 800 is configured to perform random access to a network. The network here may be a LTE network, a 5G network, or the other appropriate wireless network.

The part of UE 800 which is most affected by the adaptation to the herein described method, e.g., a part of the method 200 or the method 400, is illustrated as an arrangement 801, surrounded by a dashed line. The UE 800 could be, e.g., a mobile terminal, depending on in which type of communication system it is operable, e.g., LTE-type or 5G-type (MMW-type) systems. The UE 800 and arrangement 801 are may be further configured to communicate with other entities via a communication unit 802 which may be regarded as part of the arrangement 801. The communication unit 802 comprises means for wireless communication. The arrangement 801 or UE 800 may further comprise other functional units 804, such as functional units providing regular UE functions, and may further comprise one or more storage units 803.

The arrangement 801 could be implemented, e.g., by one or more of: a processor or a micro processor and adequate software and memory for storing of the software, a Programmable Logic Device (PLD) or other electronic component(s) or processing circuitry configured to perform the actions described above, and illustrated, e.g., in FIG. 2 or FIG. 4. The arrangement part of the UE 800 may be implemented and/or described as follows.

Referring to FIG. 8, the UE 800 may include a transmitting unit 810, a receiving unit 820, a selecting unit 830, and a random access unit 840.

The transmitting unit 810 is configured to transmit a random access request to the network. As mentioned previously, the random access request contains a preamble, which may be, e.g., selected by the UE from multiple predefined available preambles or assigned by the network, e.g., by eNB in LTE.

The receiving unit 820 is configured to receive two or more random access responses from the network. The two or more random access responses correspond to the preamble.

The selecting unit 830 is configured to select one random access response from the received two or more random access responses.

In an implementation, the selecting unit 830 randomly selects one random access response from the received two or more random access responses. Alternatively, the selecting unit 830 may select one random access response based on a certain criteria. For example, when each ID indicates two or more PDCCH or ePDCCH, the selecting unit 830 may select one random access response having the strongest receiving strength/quality among the received two or more random access responses.

The random access unit 840 is configured to use resource indicated by the selected random access response for accessing to the network. For example, the random access unit 840 may proceed with transmitting MSG3 to eNB as shown in FIG. 1, as well as subsequent random access related processing, which will be apparent to those skilled in the art and thus will not be described in detail here.

It should be noted that two or more different units in this disclosure may be logically or physically combined. For example, the transmitting unit 810 and the receiving unit 820 may be combined as one single unit, e.g., a transceiver in the UE.

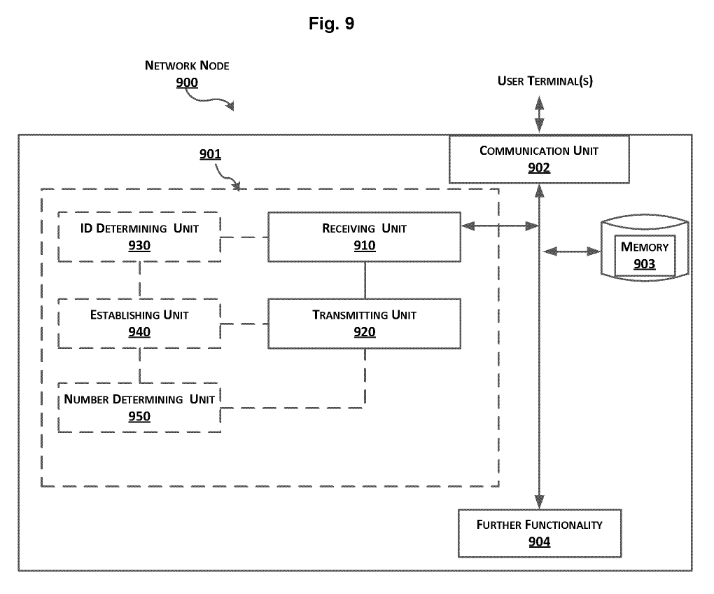

FIG. 9 is a schematic block diagram of a network node 900 according to embodiments of the present disclosure. The network node 900 is configured to control random access of one or more user terminals to the network node. The network node here may be eNB or any other network node responsible for random access in a certain coverage in the corresponding network. The network here may be a LTE network, a 5G network, or the other appropriate wireless network.

The part of network node 900 which is most affected by the adaptation to the herein described method, e.g., a part of the method 200 or the method 500, is illustrated as an arrangement 901, surrounded by a dashed line. The network node 900 could be, e.g. a base station, an eNB, or any other network node responsible for random access in a certain coverage in the corresponding network, depending on in which type of communication system it is operable, e.g., LTE-type or 5G-type (MMW-type) systems. The network node 900 and arrangement 901 are further configured to communicate with other entities via a communication unit 902 which may be regarded as part of the arrangement 901. The communication unit 902 comprises means for wireless communication, and may comprise means for, e.g., wired communication. The arrangement 901 or the network node 900 may further comprise other functional units 904, such as functional units providing regular base station functions, and may further comprise one or more storage units 903.

The arrangement 901 could be implemented, e.g., by one or more of: a processor or a micro processor and adequate software and memory for storing of the software, a Programmable Logic Device (PLD) or other electronic component(s) or processing circuitry configured to perform the actions described above, and illustrated, e.g., in FIG. 2 or FIG. 5. The arrangement part of the network node 900 may be implemented and/or described as follows.

Referring to FIG. 9, the network node 900 may include a receiving unit 910, a transmitting unit 920, an ID determining unit 930, an establishing unit 940, and a number determining unit 950. The ID determining unit 930, the establishing unit 940, and the number determining unit 950 are optional and thus depicted in dashed lines.

The receiving unit 910 is configured to receive, for each of the one or more user terminals, one or more random access requests from the user terminal. As mentioned previously, the random access request contains a preamble, which may be, e.g., selected by the UE from multiple predefined available preambles or assigned by the network node.

The transmitting unit 920 is configured to transmit, for each of the one or more user terminals, two or more random access responses to the user terminal. The two or more random access responses correspond to the preamble.

The ID determining unit 930 is configured to determine one or more IDs, each of which identifies a time-frequency slot in which the preamble is detected.

The establishing unit 940 is configured to establish one or more PDCCH or ePDCCH based on the determined one or more IDs. Each of the one or more IDs indicates one or more PDCCH or ePDCCH, and each of the one or more PDCCH or ePDCCH indicates a PDSCH payload. In this case, the transmitting unit 920 transmits one or more of the random access responses to the user terminal via the PDSCH payload.

The number determining unit 950 is configured to: determine a total number of one or more random access requests received from the one or more user terminals and containing a same preamble; and determine a total number of random access responses for the one or more random access requests, based on the total number of the one or more random access requests.

For example, the number determining unit 950 may determine the total number of the one or more random access requests, based on AoAs of signals carrying the one or more random access requests. Alternatively, the number determining unit 950 may determine the total number of the one or more random access requests, based on time difference between preamble detection peaks. Of course, the combination of these manners may be applied in determining the total number of the random access requests. This can improve accuracy of the determining.

It should be noted that two or more different units in this disclosure may be logically or physically combined. For example, the receiving unit 910 and the transmitting unit 920 may be combined as one single unit, e.g., a transceiver in the network node 900. Moreover, the ID determining unit 930 and the number determining unit 950 may be also combined as one single unit.

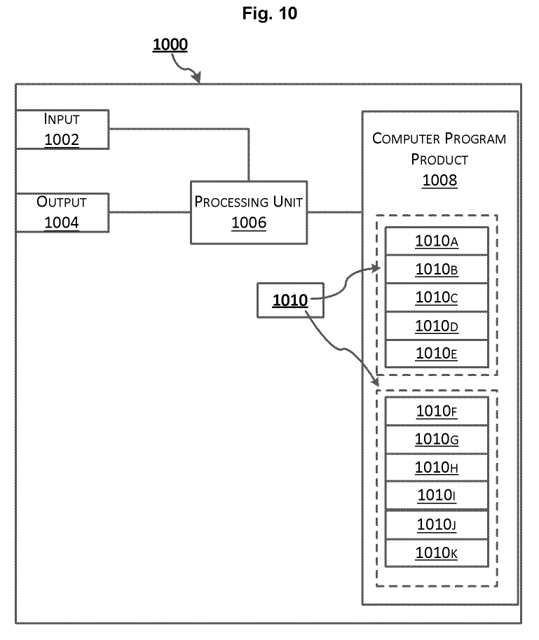

FIG. 10 schematically shows an embodiment of an arrangement 1000 which may be used in the UE 800 or the network node 900. Comprised in the arrangement 1000 are here a processing unit 1006, e.g., with a Digital Signal Processor (DSP). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit and the output unit may be arranged as an integrated entity or as illustrated in the example of FIG. 8 or FIG. 9.

Furthermore, the arrangement 1000 comprises at least one computer program product 1008 in the form of a non-volatile or volatile memory, e.g., an Electrically Erasable Programmable Read-Only Memory (EEPROM), a flash memory and a hard drive. The computer program product 1008 comprises a computer program 1010, which comprises code/computer readable instructions, which when executed by the processing unit 1006 in the arrangement 1000 causes the arrangement 1000 and/or the network node or the UE in which it is comprised to perform the actions, e.g., of the procedure described earlier in conjunction with FIG. 2 and FIG. 4 or FIG. 5.

The computer program 1010 may be configured as a computer program code structured in computer program modules 1010A-1010E or 1010F-1010K. Hence, in an exemplifying embodiment when the arrangement 1000 is used in the UE 800, the code in the computer program of the arrangement 1000 includes a transmitting module 1010A, for transmitting a random access request to the network, the random access request containing a preamble. The code in the computer program 1010 further includes a receiving module 10106, for receiving two or more random access responses from the network, the two or more random access responses corresponding to the preamble. The code in the computer program 1010 may further include a selecting module 1010C, for selecting one random access response from the received two or more random access responses. The code in the computer program 1010 may further include a random access module 1010D, for using resource indicated by the selected random access response for accessing to the network. The code in the computer program 1010 may comprise further modules, illustrated as module 1010E, e.g. for controlling and performing other related procedures associated with UE's operations.

In another exemplifying embodiment when the arrangement 1000 is used in the network node 900, the code in the computer program of the arrangement 1000 includes a receiving module 1010F, for receiving, for each of the one or more user terminals, one or more random access requests from the user terminal, the one or more random access requests containing a preamble. The code in the computer program further includes a transmitting module 1010G, for transmitting, for each of the one or more user terminals, two or more random access responses to the user terminal, the two or more random access responses corresponding to the preamble. The code in the computer program further includes an ID determining module 1010H, for determining one or more IDs, each of which identifies a time-frequency slot in which the preamble is detected. The code in the computer program further includes an establishing module 1010I, for establishing one or more PDCCH or ePDCCH based on the determined one or more IDs, each of the one or more IDs indicating one or more PDCCH or ePDCCH, and each of the one or more PDCCH or ePDCCH indicating a PDSCH payload. In this case, the transmitting module 1010G further transmits one or more of the random access responses to the user terminal via the PDSCH payload. The code in the computer program further includes a number determining module 1010J, for determining a total number of one or more random access requests received from the one or more user terminals and containing a same preamble; and determining a total number of random access responses for the one or more random access requests, based on the total number of the one or more random access requests. The code in the computer program 1010 may comprise further modules, illustrated as module 1010K, e.g. for controlling and performing other related procedures associated with the network node's operations.

The computer program modules could essentially perform the actions of the flow illustrated in FIG. 4, to emulate the arrangement 801 in the UE 800, or the actions of the flow illustrated in FIG. 5, to emulate the arrangement 901 in the network node 900. In other words, when the different computer program modules are executed in the processing unit 1006, they may correspond, e.g., to the units 810-840 of FIG. 8 or to the units 910-950 of FIG. 9.

Although the code means in the embodiments disclosed above in conjunction with FIG. 10 are implemented as computer program modules which when executed in the processing unit causes the device to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the UE.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1. A method used in a user terminal for performing random access to a network, the method comprising:
transmitting a random access request to the network, the random access request containing a preamble;
receiving two or more random access responses from the network, the two or more random access responses corresponding to the preamble;
selecting one random access response from the received two or more random access responses; and
using resource indicated by the selected random access response for accessing to the network.

2. The method of claim 1, wherein
the preamble corresponds to one or more Identities (IDs), each of which identifies a time-frequency slot in which the preamble is detected,
each of the one or more IDs indicates one or more Physical Downlink Control CHannel (PDCCH) or enhanced PDCCH (ePDCCH), and
each of the one or more PDCCH or ePDCCH indicates a PDSCH payload, in which one or more of the received random access responses are carried.

3. The method of claim 1, wherein selecting one random access response from the received two or more random access responses comprises:
randomly selecting one random access response from the received two or more random access responses; or
selecting one random access response having the strongest receiving strength among the received two or more random access responses.

4. The method of claim 1, wherein selecting one random access response from the received two or more random access responses comprises:
selecting one random access response having the strongest receiving strength among the received two or more random access responses; or
randomly selecting one random access response from the received two or more random access responses.

5-19. (canceled)

20. A user terminal, the user terminal comprising:
a processing unit; and
a computer readable medium comprising a computer program comprising computer readable instructions, which when executed by the processing unit causes the user terminal to:
transmit a random access request to the network, the random access request containing a preamble;
select one random access response from two or more random access responses transmitted by the network, the two or more random access responses corresponding to the preamble; and
use a resource indicated by the selected random access response for accessing to the network.

21. The user terminal according to claim 20, wherein the user terminal is configured such that the user terminal selects the one random access response from the received two or more random access responses by:
randomly selecting one random access response from the received two or more random access responses; or
selecting the random access response having the strongest receiving strength among the received two or more random access responses.

22. The user terminal according to claim 20, wherein
the preamble corresponds to one or more Identities (IDs), each of which identifies a time-frequency slot in which the preamble is detected,
each of the one or more IDs indicates one or more Physical Downlink Control Channel (PDCCH) or enhanced PDCCH (ePDCCH), and
each of the one or more PDCCH or ePDCCH indicates a PDSCH payload, in which one or more of the received random access responses are carried.

23. The user terminal according to claim 22, wherein the user terminal is configured such that the user terminal selects the one random access response from the received two or more random access responses by:
randomly selecting one random access response from the received two or more random access responses; or
selecting the random access response having the strongest receiving strength among the received two or more random access responses.

24. A network node, the network node comprising:
a processing unit; and
a computer readable medium comprising a computer program comprising computer readable instructions, which when executed by the processing unit causes the network node to, when controlling random access of a user terminal to the network node:
receive one or more random access requests from the user terminal, the one or more random access requests containing a preamble; and
transmit two or more random access responses to the user terminal, the two or more random access responses corresponding to the preamble.

25. The network node according to claim 24, wherein the network node is configured to:
determine one or more Identities (IDs) each of which identifies a time-frequency slot in which the preamble is detected; and
establish one or more Physical Downlink Control Channel (PDCCH) or enhanced PDCCH (ePDCCH) based on the determined one or more IDs, each of the one or more IDs indicating one or more PDCCH or ePDCCH, and each of the one or more PDCCH or ePDCCH indicating a PDSCH payload, wherein
the network node is configured to transmit the two or more random access responses to the user terminal by performing a process comprising transmitting one or more of the random access responses to the user terminal via the PDSCH payload.

26. The network node according to claim 24, wherein the network node is further configured to:
determine a total number of random access requests received from two or more user terminals and containing a same preamble; and
determine a total number of random access responses based on the determined total number of the one or more random access requests received from the two or more user terminals.

27. The network node according to claim 26, wherein the network node is configured to:
determine the total number of random access requests based on Angles of Arrivals (AoAs) of signals carrying the random access requests or time difference between preamble detection peaks.

28. The network node according to claim 25, wherein the network node is configured to:
determine a total number of random access requests received from two or more user terminals and containing a same preamble; and
determining a total number of random access responses based on the determined total number of random access requests received from the two or more user terminals.

29. The network node according to claim 28, wherein the network node is configured to:
determine the total number of the random access requests based on Angles of Arrivals (AoAs) of signals carrying the random access requests or time difference between preamble detection peaks.
